(19) United States
(12) Patent Application Publication
(10) Pub. No.: US 2026/0118555 A1
(43) Pub. Date: Apr. 30, 2026

(54) MULTILAYER OPTICAL SHEET HAVING MULTIPLE POLYGONAL GRID CELLS AND MANUFACTURING METHOD THEREOF

(71) Applicant: KINGRAY TECHNOLOGY CO., LTD., Hsinchu County (TW)

(72) Inventors: Cheng-Hsing TSOU, Hsinchu County (TW); Ta-Hsiang CHAO, Hsinchu County (TW); Yu-Wen HU, Hsinchu County (TW); Pei-Yuan NI, Hsinchu County (TW)

(21) Appl. No.: 18/925,060

(22) Filed: Oct. 24, 2024

(51) Int. Cl. G02B 1/111; G02B 1/18

(52) U.S. Cl. CPC G02B 1/111; G02B 1/18

(57) ABSTRACT

A multilayer optical sheet includes a substrate, a plurality of polygonal grid cells, a multilayer film, and two anti-fouling and water-repellent layers. The plurality of polygonal grid cells are formed on a surface of the substrate and are formed by alternately stacking a plurality of high refractive index materials and a plurality of low refractive index materials. The multilayer film is formed on a surface of the substrate that is opposite to the plurality of polygonal grid cells and is formed by alternately stacking a plurality of high refractive index materials and a plurality of low refractive index materials. The two anti-fouling and water-repellent layers are formed on two sides of the substrate to enclose the plurality of polygonal grid cells and the multilayer film inside thereof. A manufacturing method includes providing a substrate, coating photoresist, exposing, developing, vacuum coating, stripping photoresist, and coating anti-fouling and water-repellent layers.

### BACKGROUND OF THE INVENTION

### (a) Technical Field of the Invention

The present invention is applicable to lenses, heat-insulating paper, screen protective films, and the likes, and generally relates to the technical field of multilayer optical sheets having multiple polygonal grid cells and manufacturing methods thereof, and more particularly to a multilayer optical sheet having multiple polygonal grid cells and a manufacturing method thereof, including a plurality of polygonal grid cells that effectively resists glare, blocks scattered light, and has more supplementary light effects allows the eyes to shorten the light adaptation and dark adaptation periods, and also effectively blocks ultraviolet, violet, and blue light of 280-500 nm and near-infrared light in the band of 760 nm-2000 nm while maintaining high transmission of visible light.

### (b) Description of the Prior Art

Most ultraviolet light comes from sunlight, and blocking ultraviolet light has become a must for modern people's survival. Ultraviolet light is a part of the sunlight spectrum that has shorter wavelength than visible light. Ultraviolet light can be divided into UV-A (320 to 400 nm), UV-B (280 to 320 nm) and UV-C (100 to 280 nm) according to wavelength. UV-C (100 to 280 nm) will be effectively blocked by the ozone layer and will not cause UV-C damage. UV-B can cause cataracts, pterygiums, snow blindness, photokeratitis, and retinopathy. UV-A has the lowest energy, and skin tanning is the effect of UV-A. Generally speaking, the shorter the wavelength, the higher the energy and the greater the damage. The lens of our eyes absorbs most of the ultraviolet light, blocking the ultraviolet light from entering the eyeball and preventing damage to the retina. However, as the crystal lens performing this “protection mechanism” absorbs ultraviolet light, the content of insoluble protein in the fiber gradually increases and cataracts form. With the development of science and technology, people are becoming more and more dependent on 3C products. Ultraviolet light, violet light and blue light having wavelengths between 280-500 nm have high energy. Continuously receiving light in this region will have an impact on the health of the retina; and many 3C products, including flat panel displays, LED neon lights, fluorescent lamps, computer monitors, and mobile phone screens, all contain abnormally high-energy blue light in light sources thereof that are excited by electron flows. The prior art technologies are only effective in blocking the ultraviolet and blue light parts. However, according to the literature study of “Chinese Medical Association-Criteria for Identification of Cataracts Caused by Heat Rays”, the absorption of infrared light for iris becomes larger when the iris is in the infrared wavelength range of 760-2000 nm. The iris and lens absorb the radiant heat energy that strikes the eye, and burns may occur if the exposure is too large. In addition, the iris is very sensitive to temperature, and high-power infrared light may cause severe pain in the eyes. Even if the exposure to high-power near-infrared light is only a short time, the heat energy conducted by the iris is still the main cause of cataracts. As to long-term exposure to low-energy infrared light, the crystal directly absorbs heat energy, causing diseases of chronic cataracts. High-intensity infrared light can damage proteins, and usually, proteins must be arranged accurately to ensure that the crystal lens is clear and the crystal lens can correctly focus light. If the proteins are damaged and arranged into irregular piles, the lens will become cloudy, which is what we usually call cataracts. Over time, the opacity area expands or the concentration increases, resulting in a decrease in the light transmittance of the lens, eventually causing visual impairment.

In addition to the above, sunlight usually shines in all directions. When it hits an object, the light is redirected and reflected, forming two types of reflected light, which are horizontal and vertical. The above-mentioned horizontal reflected light is dazzling random reflected light, also known as horizontal glare, which is the useless light that actually affects the line of sight and causes glare. This horizontal glare is more dangerous and can cause temporary blindness in humans. If the driver encounters horizontal glare entering his eyes while driving, temporary blindness may be caused, resulting in incapability of clearly seeing the road ahead, thereby putting the driver and other road users in danger. The characteristic of general polarizer glasses is filtering all horizontal reflected light and leaving only vertical light. Generally, when driving on the road from dusk to night, human eyes can still adapt to the changes in light during this period, but when driving to suddenly enter a tunnel or in long boulevards, the eyes cannot see anything in a short period of time, because human eyes have problems of light adaptation and dark adaptation. Light adaptation is the adaptation period from a dark place to a bright place, which takes about a few seconds to tens of seconds. And, the dark adaptation period is the adaptation period from a bright place to a dark place, and takes several minutes to tens of minutes to adapt. Therefore, if polarizer sunglasses are worn for intense sunlight, when going into a tunnel or a boulevard or a lower layer of a multi-layer road in a modern city, the problems of dark adaptation and light adaptation will become more serious because there is no vertical light and the horizontal light is blocked. This will lead to endless problems of serious traffic accidents.

### SUMMARY OF THE INVENTION

The primary objective of the present invention is to resolve the issues of damage of human eyes caused by ultraviolet, violet, and blue light of 280-500 nm and the near-infrared in the waveband of 760 nm-2000 nm existing in daily living and to improve of the problems of regular polarizer glasses with respect to “light adaptation” and “dark adaptation”.

The present invention provides a multilayer optical sheet having multiple polygonal grid cells, which comprises a substrate, a plurality of polygonal grid cells, a multilayer film, and two anti-fouling and water-repellent layers. The plurality of polygonal grid cells are formed through vacuum coating on one surface of the substrate and are formed of alternately stacking a plurality of high refractive index materials and a plurality of low refractive index materials to effectively resist glare, block scattered light. The multilayer film is formed through vacuum coating on one surface of the substrate that is opposite to the plurality of polygonal grid cell and is formed by alternately stacking a plurality of high refractive index materials and a plurality of low refractive index materials to effectively block ultraviolet, violet, and blue light of 280-500 nm and near infrared light in the waveband of 760 nm-2000 nm. The two anti-fouling and water-repellent layers are formed through vacuum coating by attaching a water repellent agent to outside of the plurality of polygonal grid cells and the multilayer film, so as to have the plurality of polygonal grid cells enclosed by one of the anti-fouling and water-repellent layers and the substrate and the multilayer film sandwiched between another one of the anti-fouling and water-repellent layers and the substrate.

The present invention provides a method for manufacturing a multilayer optical sheet having multiple polygonal grid cells, which comprises providing a substrate; coating photoresist: uniformly coating a photoresist on one surface of the substrate, and subsequently subjecting the coated substrate to a soft bake operation; exposing: placing the substrate coated with the photoresist into an exposure apparatus to subject the photoresist to exposure with an exposure process parameter, a light source, and a photomask carrying a pattern, and subsequently, placing the substrate into a baking oven to carry out a curing and shape-setting operation; developing: operating a development machine to clean the photoresist after exposure on the substrate with a developer in order to generate a photoresist layer having a pattern effect corresponding to the photomask, washing the developed substrate with deionized water to remove the developer remaining on the substrate and the photoresist layer; vacuum coating: coating two multilayer films respectively on the surface of the substrate having the photoresist layer and the surface opposite to the photoresist layer; stripping photoresist: applying a photoresist stripping agent to strip and remove the photoresist from the surface of the substrate carrying the pattern, and at the same time of removing the photoresist layer, removing the multilayer film attached to a top of the photoresist layer, while leaving the multilayer film attached to the substrate to form a plurality of polygonal grid cells; and coating anti-fouling and water-repellent layers: applying vacuum coating to attach a water repellent agent to outermost layers of the substrate.

The multilayer optical sheet having multiple polygonal grid cells, and the manufacturing method thereof, provided in the present invention uses the plurality of polygonal grid cells to effectively resist glare, block scattered light, and fulfill more light supplementing effect to shorten the light adaptation and dark adaptation periods for eyes and uses an arrangement of multiple layers of high refractive index materials and low refractive index materials for the multilayer film for further effectively blocking ultraviolet, violet, and blue light of 280-500 nm and near infrared light in the waveband of 760 nm-2000 nm, while maintaining high transmittal performance for visible light.

### BRIEF DESCRIPTION OF THE DRAWINGS

FIG. 1 is a schematic vie showing a structure of the present invention.

FIG. 2 is a schematic view showing a manufacturing process of the present invention.

FIG. 3 is a plot showing comparison between an anti-reflective light, anti-ultraviolet, violet, and blue light, and anti-infrared transmittance spectrum and a spectrum of a prior art anti-reflective film.

FIG. 4 is a diagram illustrating the size of a plurality of polygonal grid cells (grid cells of a honeycomb configuration) according to the present invention.

### DETAILED DESCRIPTION OF THE PREFERRED EMBODIMENTS

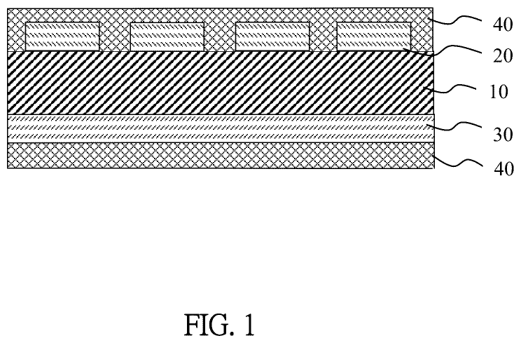

Referring to FIG. 1, a multilayer optical sheet having multiple polygonal grid cells according to the present invention is shown, comprising a substrate 10, a plurality of polygonal grid cells 20, a multilayer film 30, and two anti-fouling and water-repellent layers 40.

The substrate 10 is made of a material that can be glass, polycarbonate (PC), poly(methyl methacrylate) (PMMA), or resin (CR39, MR7, MR8, MR174).

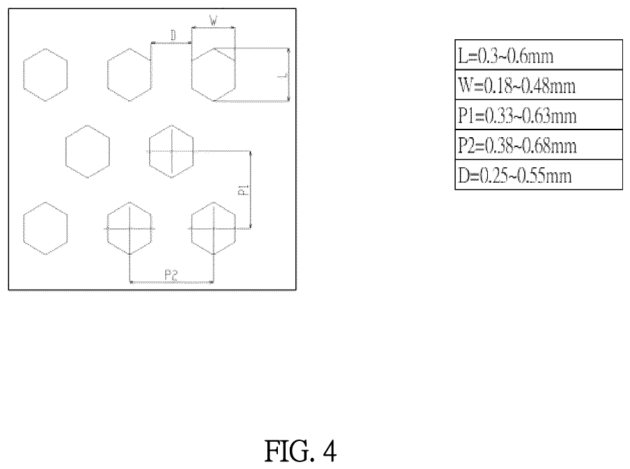

The plurality of polygonal grid cells 20 are formed on one surface of the substrate 10 through an operation of vacuum coating, and are formed by alternately stacking a plurality of high refractive index materials and a plurality of low refractive index materials, and are preferably of a hexagonal configuration, making the entirety thereof generally illustrating a honeycomb configuration (as shown in FIG. 4). Each of the polygonal grid cells 20 has a height of 0.3-0.6 mm and a width of 0.18-0.48 mm, and a distance between center points of two polygonal grid cells 20 that are adjacent horizontally is 0.38-0.68 mm, while a distance between center points of two polygonal grid cells 20 that are adjacent vertically is 0.33-0.63 mm. For use in eyeglasses, the relevant proportions can be reduced in equal proportions, and for use on car front insulation paper or glass that needs to prevent horizontal glare when viewing the sea view, enlargement in equal proportions may be made. The high refractive index materials are one or more oxides, such as Ti₃O₅, TiO₂, Ta₂O₅, and Nb₂O₅, having a refractive index of 2-3 and an extinction coefficient close to 0. The low refractive index materials are one or more oxides, such as SiO₂ and MgF₂, having a refractive index of 1.3-2 and an extinction coefficient close to 0. As such, the plurality of polygonal grid cells 20 can effectively resist glare and block scattered light.

The multilayer film 30 is formed on a surface of the substrate 10 that is opposite to the plurality of polygonal grid cells 20 through an operation of vacuum coating and is formed by alternately stacking a plurality of high refractive index materials and a plurality of low refractive index materials. The high refractive index materials are one or more oxides, such as Ti₃O₅, TiO₂, Ta₂O₅, and Nb₂O₅, having a refractive index of 2-3 and an extinction coefficient close to 0. The low refractive index materials are one or more oxides, such as SiO₂ and MgF₂, having a refractive index of 1.3-2 and an extinction coefficient close to 0. As such, the multilayer film 30 has a function of resisting reflective light, resisting ultraviolet, violet, and blue light, and resisting infrared light.

The two anti-fouling and water-repellent layers 40 are formed by applying an operation of the vacuum coating to attach a water repellent agent to outsides of the plurality of polygonal grid cells 20 and the multilayer film 30, so that the plurality of polygonal grid cells 20 are enclosed by one of the anti-fouling and water-repellent layers 40 and the substrate 10, and the multilayer film 30 is sandwiched between the other one of the anti-fouling and water-repellent layers 40 and the substrate 10.

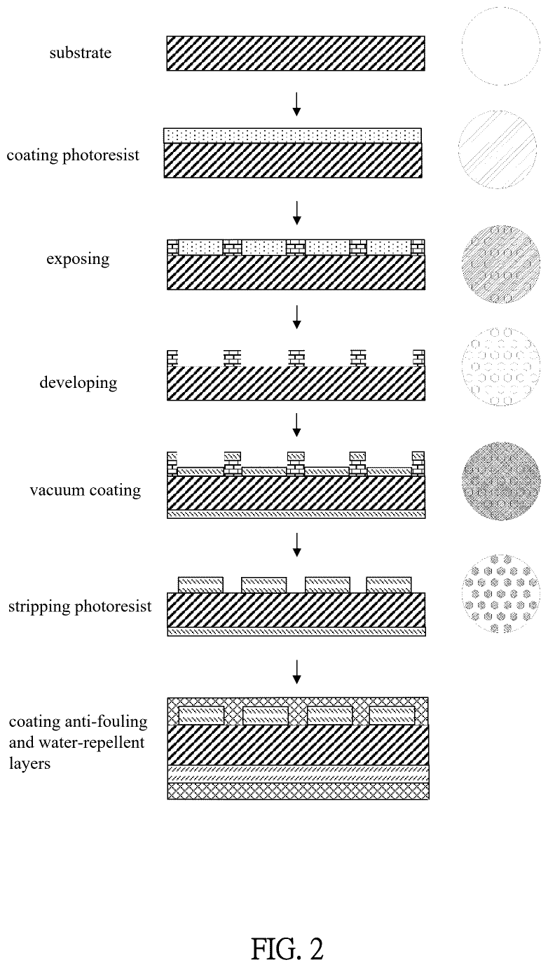

Referring to FIG. 2, a method for manufacturing a multilayer optical sheet having multiple polygonal grid cells according to the present invention is illustrating, comprising the following steps:

providing substrate: a material of the substrate being glass, PC, PMMA, or resin (CR39, MR7, MR8, MR174);

coating photoresist: uniformly coating a photoresist on one surface of the substrate, and after completion of the coating, placing the substrate so coated into a baking oven to carry out a soft bake operation with a soft bake parameter, wherein coating of photoresist is implemented with a spin coater or a sprayer and can be implemented with any equipment that is capable of uniformly coating the photoresist on the substrate, but not limited thereto, wherein the photoresist can be selected as a positive photoresist or a negative photoresist;

exposing: placing the substrate on which the photoresist is coated into an exposure apparatus to subject the photoresist to exposure with an exposure process parameter, a light source, and a photomask carrying a pattern, and placing the substrate so subjected to exposure into a baking oven to carry out a curing and shape-setting operation with a curing parameter, wherein the exposure apparatus can be an aligner, and any equipment that satisfies requirements for pattern resolution and exposure condition can be used, but not limited thereto; and the photomask includes a plurality of polygonal patterns, the polygonal patterns being preferably hexagons, and individual hexagons of the plurality of polygons of the photomask plate are arranged in a raising-recessing alternating fashion, so that, after stripping of the photoresist, the plurality of hexagonal multilayer films are not adjacent to each other but are connected to the adjacent hexagonal multilayer film;

developing: operating a development machine to remove an exposed portion of the photoresist from the substrate that has been subjected to the curing and shape-setting operation with a developer, so as to form a photoresist layer having a pattern corresponding to the photomask, cleaning the substrate so developed with deionized water to remove the developer remaining on the substrate and the photoresist layer, wherein an operation of one of spraying, soaking, rinsing, and ultrasonic vibration, or a combination thereof is applied as a measure of cleaning the developer, but not limited thereto, wherein a photoresist layer having a pattern corresponding to the photomask is generated after the exposed portion of photoresist is cleaned and removed with the developer, for example for a negative photoresist, an unexposed potion dissolving in developer, while a portion irradiated with UV not dissolving in the photoresist developer, and on the contrast, for a positive photoresist, an exposed portion dissolving in the developer, while a portion irradiated with UV not dissolving in the photoresist developer, exposure condition being adjustable as desired;

vacuum coating: subjecting two surfaces of the substrate that is formed with the photoresist layer to an operation of vacuum coating, wherein physical vapor deposition or chemical vapor deposition is applied to deposit, on the substrate, two multilayer films on the surface that has the photoresist layer and the surface that is opposite to the photoresist layer, respectively, and the two multilayer films are each formed by alternately stacking a plurality of high refractive index materials and a plurality of low refractive index materials, wherein the high refractive index materials high refractive index materials are one or more oxides, such as Ti₃O₅, TiO₂, Ta₂O₅, and Nb₂O₅, having a refractive index of 2-3 and an extinction coefficient close to 0, and the low refractive index materials are one or more oxides, such as SiO₂ and MgF₂, having a refractive index of 1.3-2 and an extinction coefficient close to 0, and the anti-blue light property of the multilayer films is 10%-50%, and anti-infrared property is 30%-70%;

stripping photoresist: applying a photoresist stripping agent (PH-strip) to strip and remove the photoresist from the surface of the substrate carrying the pattern, and at the same time of removing the photoresist layer, removing the multilayer film attached to a top of the photoresist layer, while leaving the multilayer film attached to the substrate, which are the plurality of polygonal grid cells 20 (as shown in FIG. 4), wherein each of the polygonal grid cells 20 has a height of 0.3-0.6 mm and a width of 0.18-0.48 mm, and a distance between center points of two polygonal grid cells 20 that are adjacent horizontally is 0.38-0.68 mm, while a distance between center points of two polygonal grid cells 20 that are adjacent vertically is 0.33-0.63 mm, and as such, the plurality of polygonal grid cells 20 can effectively resist glare and block scattered light, while enabling more light supplementing effect with non-coated regions, shortening the light adaptation and dark adaptation periods for eyes, and wherein for use in eyeglasses, the relevant proportions can be reduced in equal proportions, and for use on car front insulation paper or glass that needs to prevent horizontal glare when viewing the sea view, enlargement in equal proportions may be made, wherein the PR strip agent contains a combination of solvents, such as N-methyl-2-pyrrolidone (NMP), dimethyl sulfoxide (DMSO), and glycol ethers, but not limited thereto; and

coating anti-fouling and water-repellent layers: applying an operation of vacuum coating to attach a water repellent agent to outermost layers of the substrate.

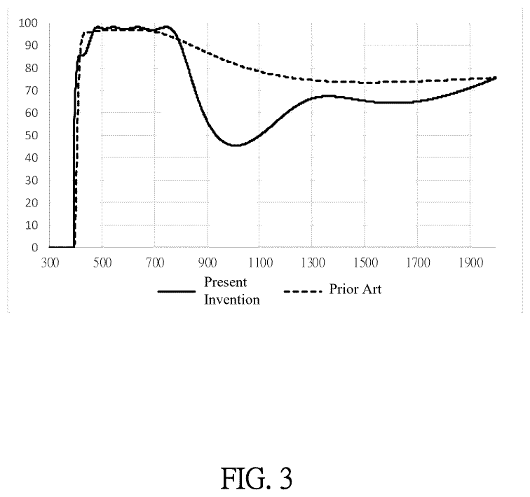

The present invention provides a multilayer optical sheet having multiple polygonal grid cells, and a manufacturing method thereof, which includes a plurality of polygonal grid cells 20 for effectively resisting glare, blocking scattered light, and fulfilling more light supplementing effect to shorten the light adaptation and dark adaptation periods for eyes, and includes an arrangement of multiple layers of high refractive index materials and low refractive index materials for the multilayer film 30 for further effectively blocking ultraviolet, violet, and blue light of 280-500 nm and near infrared light in the waveband of 760 nm-2000 nm, while maintaining high transmittal performance for visible light. Reference is made to FIG. 3, which provides a plot showing comparison between an anti-reflective light, anti-ultraviolet, violet, and blue light, and anti-infrared transmittance spectrum and a spectrum of a prior art anti-reflective film.

I claim:

1. A multilayer optical sheet having multiple polygonal grid cells, comprising:
a substrate;
a plurality of polygonal grid cells, which are formed through vacuum coating on one surface of the substrate and are formed of alternately stacking a plurality of high refractive index materials and a plurality of low refractive index materials to effectively resist glare, block scattered light, and provides more effect of light supplementing, so as to shorten light adaptation and dark adaptation periods for eyes;
a multilayer film, which is formed through vacuum coating on one surface of the substrate that is opposite to the plurality of polygonal grid cell and is formed by alternately stacking a plurality of high refractive index materials and a plurality of low refractive index materials to effectively block ultraviolet, violet, and blue light of 280-500 nm and near infrared light in the waveband of 760 nm-2000 nm; and
two anti-fouling and water-repellent layers, which are formed through vacuum coating by attaching a water repellent agent to outside of the plurality of polygonal grid cells and the multilayer film, so as to have the plurality of polygonal grid cells enclosed by one of the anti-fouling and water-repellent layers and the substrate and the multilayer film sandwiched between another one of the anti-fouling and water-repellent layers and the substrate.

2. The multilayer optical sheet having multiple polygonal grid cells according to claim 1, wherein a material of the substrate is one of glass, polycarbonate (PC), poly(methyl methacrylate) (PMMA), or resin (CR39, MR7, MR8, MR174).

3. The multilayer optical sheet having multiple polygonal grid cells according to claim 1, wherein the plurality of polygonal grid cells are preferably hexagonal shapes.

4. The multilayer optical sheet having multiple polygonal grid cells according to claim 3, wherein the plurality of polygonal grid cells are of a honeycomb configuration.

5. The multilayer optical sheet having multiple polygonal grid cells according to claim 1, wherein the high refractive index materials of the plurality of polygonal grid cells and the multilayer film are one or more oxides having a refractive index 2-3 and an extinction coefficient close to 0, and the low refractive index materials are one or more oxides having a refractive index of 1.3-2 and an extinction coefficient close to 0.

6. The multilayer optical sheet having multiple polygonal grid cells according to claim 5, wherein the high refractive index materials are one of Ti₃O₅, TiO₂, Ta₂O₅, and Nb₂O₅.

7. The multilayer optical sheet having multiple polygonal grid cells according to claim 5, wherein the low refractive index materials are one of SiO₂ and MgF₂.

8. The multilayer optical sheet having multiple polygonal grid cells according to claim 1, wherein each of the polygonal grid cells has a height of 0.3-0.6 mm and a width of 0.18-0.48 mm, and a distance between center points of two polygonal grid cells 20 that are adjacent horizontally is 0.38-0.68 mm, and a distance between center points of two polygonal grid cells that adjacent vertically is 0.33-0.63 mm.

9. The multilayer optical sheet having multiple polygonal grid cells according to claim 8, wherein the height, width, horizontally adjacent center point distance, and vertically adjacent center point distances of the polygonal grid cells are reducible/enlargeable with equal proportion for a product to which an application thereof is made.

10. A method for manufacturing a multilayer optical sheet having multiple polygonal grid cells, comprising the following steps:
providing a substrate;
coating photoresist: uniformly coating a photoresist on one surface of the substrate, and subsequently subjecting the coated substrate to a soft bake operation;
exposing: placing the substrate coated with the photoresist into an exposure apparatus to subject the photoresist to exposure with an exposure process parameter, a light source, and a photomask carrying a pattern, and subsequently, placing the substrate into a baking oven to carry out a curing and shape-setting operation;
developing: operating a development machine to clean the photoresist after exposure on the substrate with a developer in order to generate a photoresist layer having a pattern effect corresponding to the photomask, washing the developed substrate with deionized water to remove the developer remaining on the substrate and the photoresist layer;
vacuum coating: coating two multilayer films respectively on the surface of the substrate having the photoresist layer and the surface opposite to the photoresist layer, the multilayer films effectively blocking ultraviolet, violet, and blue light of 280-500 nm and near infrared light in the waveband of 760 nm-2000 nm;
stripping photoresist: applying a photoresist stripping agent to strip and remove the photoresist from the surface of the substrate carrying the pattern, and at the same time of removing the photoresist layer, removing the multilayer film attached to a top of the photoresist layer, while leaving the multilayer film attached to the substrate to form a plurality of polygonal grid cells, the plurality of polygonal grid cells effectively resisting glare and blocking scattered light; and
coating anti-fouling and water-repellent layers: applying vacuum coating to attach a water repellent agent to outermost layers of the substrate.

11. The method for manufacturing a multilayer optical sheet having multiple polygonal grid cells according to claim 10, wherein a material of the substrate is one of glass, PC, PMMA, and resin (CR39, MR7, MR8, MR174).

12. The method for manufacturing a multilayer optical sheet having multiple polygonal grid cells according to claim 10, wherein the photomask includes a plurality of polygonal patterns.

13. The method for manufacturing a multilayer optical sheet having multiple polygonal grid cells according to claim 12, the photomask including a plurality of polygonal patterns, wherein individual hexagons of the plurality of polygons of the plurality of polygonal photomask plates are arranged in a raising-recessing alternating fashion so that a majority of the plurality of multilayer films each having a hexagonal shape after removing of the photoresist are not adjacent to each other but connected to the adjacent hexagonal multilayer film.

14. The method for manufacturing a multilayer optical sheet having multiple polygonal grid cells according to claim 10, wherein the two multilayer films are formed by alternately stacking a plurality of high refractive index materials and a plurality of low refractive index materials, the high refractive index materials comprising one or more oxides having a refractive index of 2-3 and an extinction coefficient close to 0, the low refractive index materials comprising one or more oxides having a refractive index of 1.3-2 and an extinction coefficient close to 0.

15. The method for manufacturing a multilayer optical sheet having multiple polygonal grid cells according to claim 14, wherein the high refractive index materials are one of Ti₃O₅, TiO₂, Ta₂O₅, and Nb₂O₅.

16. The method for manufacturing a multilayer optical sheet having multiple polygonal grid cells according to claim 14, wherein the low refractive index materials are one of SiO₂ and MgF₂.

17. The method for manufacturing a multilayer optical sheet having multiple polygonal grid cells according to claim 14, wherein the multilayer films having an anti-blue light property of 10%-50% and an anti-infrared property of 30%-70%.

18. The method for manufacturing a multilayer optical sheet having multiple polygonal grid cells according to claim 10, wherein each of the polygonal grid cells has a height of 0.3-0.6 mm and a width of 0.18-0.48 mm, and a distance between center points of two polygonal grid cells 20 that are adjacent horizontally is 0.38-0.68 mm, and a distance between center points of two polygonal grid cells that adjacent vertically is 0.33-0.63 mm.

19. The method for manufacturing a multilayer optical sheet having multiple polygonal grid cells according to claim 18, wherein the height, width, horizontally adjacent center point distance, and vertically adjacent center point distances of the polygonal grid cells are reducible/enlargeable with equal proportion for a product to which an application thereof is made.
